(19) United States
(12) Patent Application Publication
(10) Pub. No.: US 2021/0393059 A1
(43) Pub. Date: Dec. 23, 2021

(54) CONTAINER WITH RECESSED HANDLE

(71) Applicant: Sky Chain Trading Ltd., Hong Kong (CN)

(72) Inventors: Steven LEW, Hong Kong (CN); Craig Anthony HOLLAN, Hong Kong (CN)

(73) Assignee: Sky Chain Trading Ltd., Hong Kong (CN)

(21) Appl. No.: 17/292,118

(22) PCT Filed: Nov. 8, 2019
(86) PCT No.: PCT/IB2019/001195

§ 371 Date: May 7, 2021

Related U.S. Application Data
(60) Provisional application No. 62/758,176, filed on Nov. 9, 2018.

(51) Int. Cl. A47G 21/14; B65D 43/26; B65D 45/02; A47J 47/16

(52) U.S. Cl. CPC A47G 21/14; A47J 47/16; B65D 45/02; B65D 43/26

(57) ABSTRACT

A container includes a recessed “one touch” mechanism positioned about the top surface of the lid (101,201,301,401,505,605). The lid (101,201,301,401,50 5,605) has a recessed area configured to house a handle (213,313,413,501,601). The handle (213,313,413,501,601) has a top surface configured to fit in the recessed area and is connected to a shank (513,613) engaged with a chamber (511,611) by way of a spring (801), wherein the handle (213,313,413,501,601) is in a first position with the recessed area when force is applied to the top surface of the handle (213,313,413,501,601), and the handle (213,313,413,501,601) is in a second position exterior to a surface of the lid (101,201,301,401,505,605) when the force is removed from the top surface of the handle (213,313,413,501,601) so that it is convenient for the user to lift the lid (101,201,301,40 1,505,605) without using both hands and leaving unwanted fingerprints on the lid (101,201,301,401,505,605).

### RELATED APPLICATIONS

The present disclosure claims priority to and the benefit of U.S. Provisional Application No. 62/758,176 filed Nov. 9, 2018, the contents of which are hereby incorporated by reference in their entirety.

### TECHNICAL FIELD

The present disclosure is directed towards a container with a recessed handle.

### BACKGROUND

Containers often hold objects that a user may not want exposed to the environment. For example, knives are commonly held in knife blocks. Often times, when lids are placed on a container, a user may have to lift the lid using both hands to access the contents of the container. For example, with knife blocks, a lid that covers the entirety of the knife block may not be able to lifted with a single hand. This may provide disadvantages in that a user may be unable to access their knives by lifting the lid without using both hands, which poses challenges when one hand is occupied with other tasks. Further, depending on the composition of the lid, using hands to lift the lid may leave unwanted fingerprints on the lid (e.g., fingerprints on stainless steel lids).

### SUMMARY

Embodiments of the present disclosure include a container with a recessed handle. In some embodiments, the recessed handle may be positioned on a lid portion of the container. In some embodiments, the container is configured to hold knives (e.g., a knife block). In some embodiments the container may be substantially egg-shaped.

In some embodiments a container includes a lid portion having a recessed area configured to house a handle, the handle having a top surface configured to fit in the recessed area, the handle being connected to a shank engaged with a chamber by way of a spring, a base portion configured to store one or more knives and engage with the lid portion, where the handle is in a first position within the recessed area when force is applied to the top surface of the handle, and the handle is in a second position exterior to a surface of the lid portion when the force is removed from the top surface of the handle.

Optionally, the container is a substantially egg-shape. Optionally, in some embodiments, a first end of the spring is fixedly attached to the interior base of the chamber. Optionally, in some embodiments, a second end of the spring is fixedly attached to the shank. Optionally, in some embodiments, the base portion includes one or more apertures configured to store the one or more knives. Optionally, in some embodiments, the base portion includes a lip configured to provide a surface onto which the lid portion may rest.

In some embodiments, a method includes depressing a portion of a handle of a container towards the interior of the container by applying a force, where the handle is positioned on a lid of the container, removing the force applied to the handle such that the handle moves towards the exterior of the container and is located outside of the surface of the container, and removing the lid from the container via the handle. Optionally, the method may also include the steps of engaging the lid with the container, where the handle protrudes from the lid, and depressing the handle such that the handle is flush with an exterior surface of the lid. Optionally, the handle of the container may be flush with the exterior surface of the container in a first state.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 illustrates a front side view of an exterior of a container in accordance with some embodiments of the present disclosure.

FIG. 2 illustrates an interior view of a container in accordance with some embodiments of the present disclosure.

FIGS. 3A and 3B illustrate interior views of a container in accordance with some embodiments of the present disclosure.

FIG. 4A illustrates a top view of the interior of a container in accordance with some embodiments of the present disclosure.

FIGS. 4B and 4C illustrate side views of an interior of a container in accordance with some embodiments of the present disclosure.

FIG. 4D illustrates a top view of a component of the container in accordance with some embodiments of the present disclosure.

FIGS. 4E and 4F illustrate side views of a component of the container in accordance with some embodiments of the present disclosure.

FIG. 5A illustrates an interior view of a component of the container in accordance with some embodiments of the present disclosure.

FIG. 5B illustrates a cross-sectional view of a component of the container in a first position in accordance with some embodiments of the present disclosure.

FIG. 5C illustrates a cross-sectional view of a component of the container in a second position in accordance with some embodiments of the present disclosure.

FIG. 5D illustrates a cross-sectional view of a component of the container in the second position in accordance with some embodiments of the present disclosure.

FIG. 5E illustrates an exterior view of a component of the container in the second position in accordance with some embodiments of the present disclosure.

FIG. 5F illustrates a cross-sectional view of a component of the container in a first position in accordance with some embodiments of the present disclosure.

FIG. 5G illustrates a cross-sectional view of a component of the container in a first position in accordance with some embodiments of the present disclosure.

FIG. 6A illustrates a cross-sectional view of a component of the container in a first position in accordance with some embodiments of the present disclosure.

FIG. 6B illustrates a cross-sectional view of a component of the container in a first position in accordance with some embodiments of the present disclosure.

FIG. 7 the interior top surface of a container in accordance with some embodiments of the present disclosure.

FIG. 8 illustrates a schematic view of a top portion of the container in accordance with some embodiments of the present disclosure.

FIG. 9 illustrates a front view of the container in accordance with some embodiments of the present disclosure.

FIG. 10 illustrates a front view of a bottom portion of the container in accordance with some embodiments of the present disclosure.

FIG. 11 illustrates a top view of a component of the container in accordance with some embodiments of the present disclosure.

FIG. 12 illustrates a top view of the container in accordance with some embodiments of the present disclosure.

### DETAILED DESCRIPTION

Embodiments of the present disclosure include a container with a recessed handle. In some embodiments, the recessed handle may be positioned on a lid portion of the container. In some embodiments, the container is configured to hold knives (e.g., a knife block). In some embodiments the container may be substantially egg-shaped.

In some embodiments, the knife block cover or lid of the container has a recessed mechanism in the top. Advantageously, the recessed mechanism can be operated using an elbow or the heel of the hand, so a user would not need to touch either the knife block or the egg-shaped knife block cover with dirty hands during cooking.

In some embodiments, the recessed handle allows the lid to cover or be removed easily via a “one touch” mechanism. Accordingly, the user may not have to physically touch (or dirty) the knife block itself. The “one touch” mechanism may be fully recessed (tucked into) and follow the curve of the lid itself. The “one touch” mechanism may allow for more precise control over the positioning of the lid and may provide additional safety benefits.

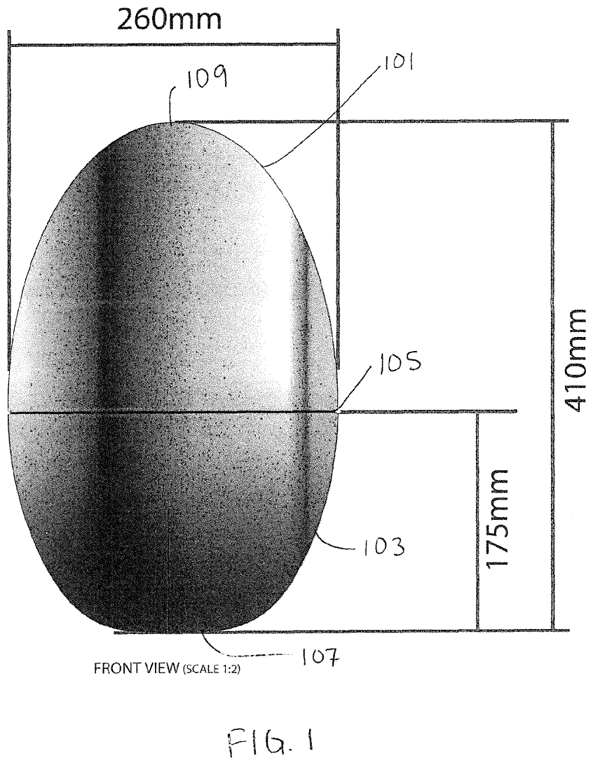

FIG. 1 illustrates a front side view of an exterior of a container in accordance with some embodiments of the present disclosure. The container illustrated in FIG. 1 is depicted as being substantially egg-shaped. The container may include a top portion or lid 101 and a bottom portion 103. The bottom portion may have a flat bottom surface 107 configured to sit on a surface (e.g., kitchen counter). The lid 101 may be configured to engage 105 with the bottom portion 103 by interfacing with a lip of the bottom portion 103. The lip of the bottom portion 103 may be positioned to face the interior of the top portion or lid 101. The lid 101 may include a top surface 109 that is substantially rounded. The container may be ovally shaped. The container may be formed of plastic, of stainless steel, or any other suitable material.

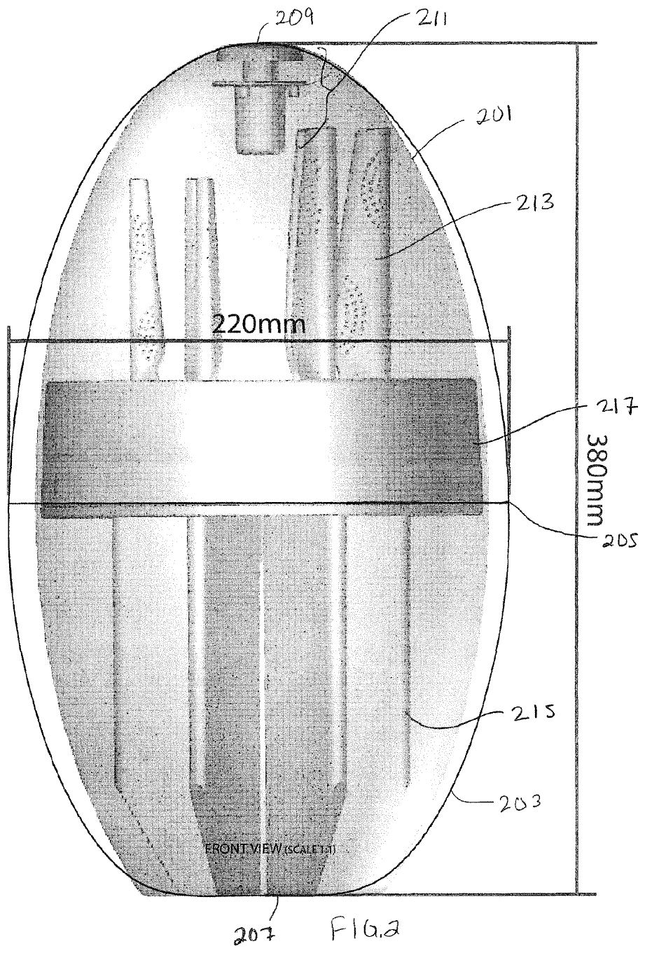

FIG. 2 illustrates an interior view of a container in accordance with some embodiments of the present disclosure. As illustrated in FIG. 2, a lid 201 may rest 205 on a bottom portion 203 having a flat bottom surface 207. The interior of the container may include a knife block 217 that is configured to hold one or more knives. The knife block 217 may include one or more apertures each configured to hold one or more knives. In some embodiments, the apertures may be sized to allow the passage of the blade portion of a knife 215, and not a handle portion of the knife 213. In some embodiments, the sharp edge of the knife 215 may be oriented downwards such that the handle 213 of the knife protrudes upwards from the knife block 217. Accordingly, a person who removes the lid 201 may have access to the knife block 217. Then the user may securely remove or place the knife into the knife block 217.

As illustrated in FIG. 2, the container may also include a recessed “one touch” mechanism positioned about the top surface 209 of the lid 201. As will be discussed further below, in some embodiments, the lid includes a “one touch mechanism” 211 where a handle is configured to reversibly extend from the lid of the container. In a first step a user depresses a portion of the handle, pushing that portion of the handle towards the interior of the container. In a second step, the user removes the force, and the handle extends from the lid of the container. The user may then use the handle to remove the lid from the bottom portion of the container. Additionally, the handle can return to its resting position where it is flush with the surface of the lid by pressing on the handle.

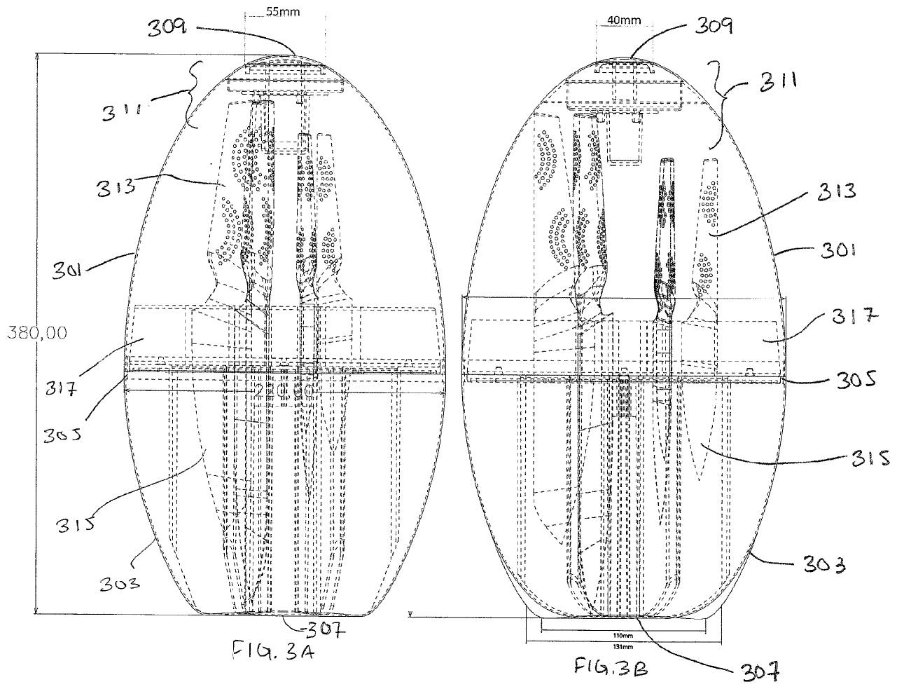

FIGS. 3A and 3B illustrate interior views of a container in accordance with some embodiments of the present disclosure. As illustrated in FIGS. 3A and 3B, the recessed portion of the top surface of 309 of lid 301 may have various widths. In some embodiments, the widths of the recessed portion of the top surface 309 of lid 301 may correspond with the diameter of a circular handle for the “one touch mechanism” 311. As illustrated in the interior views of FIGS. 3A and 3B, the top lid 301 may rest 305 on a bottom portion 303. A knife block 317 may be contained within the interior of the container and be configured to receive knives with sharp edges 315 and handles 313. As illustrated, the knives may be of different shapes and sizes. The bottom portion 303 may include a flat bottom surface 307 configured to sit on a surface such as a kitchen counter.

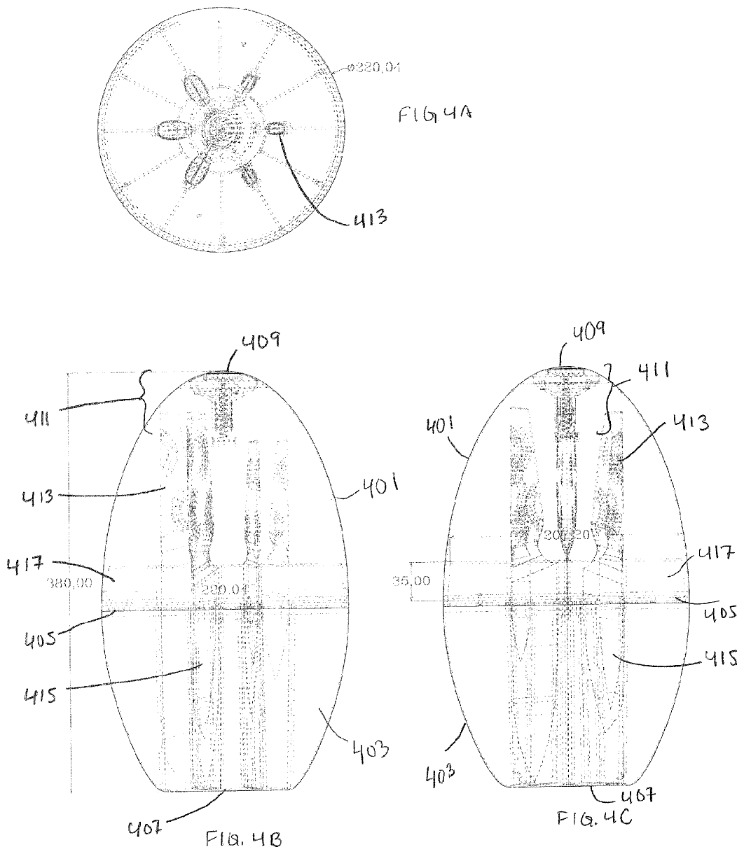

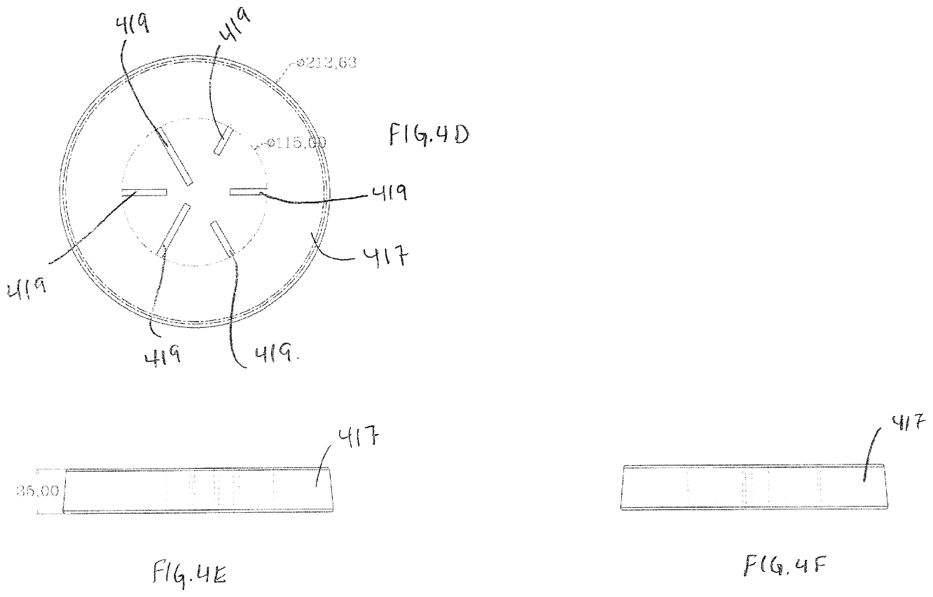

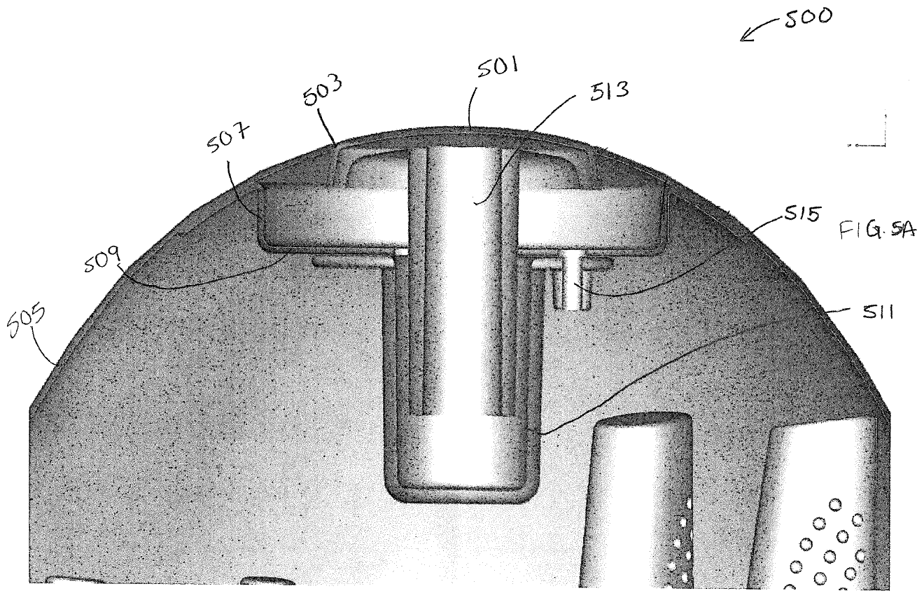

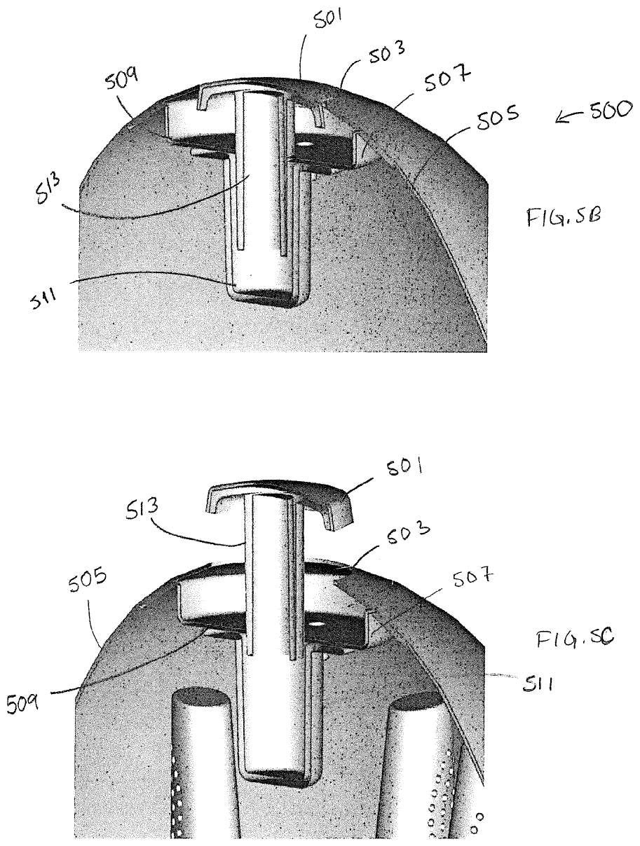

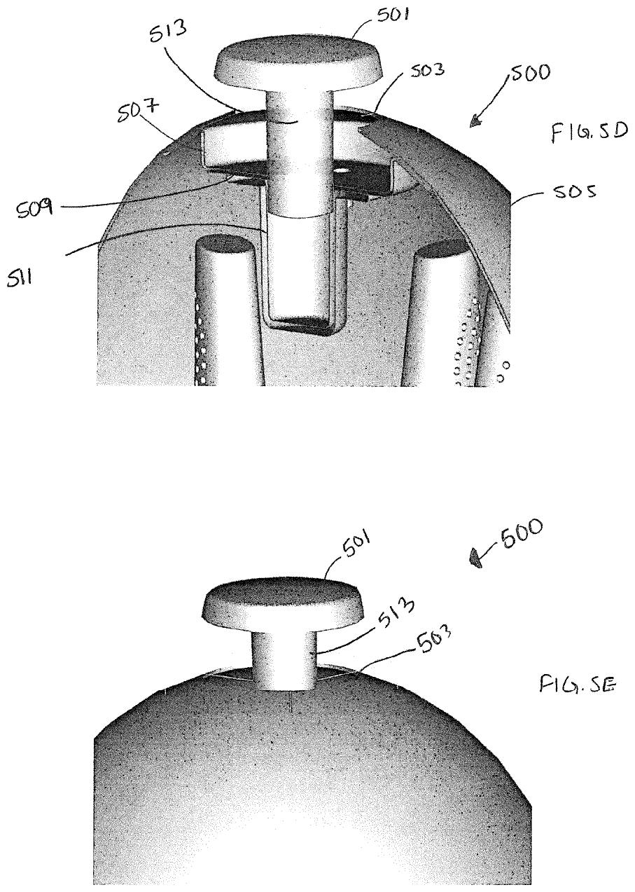

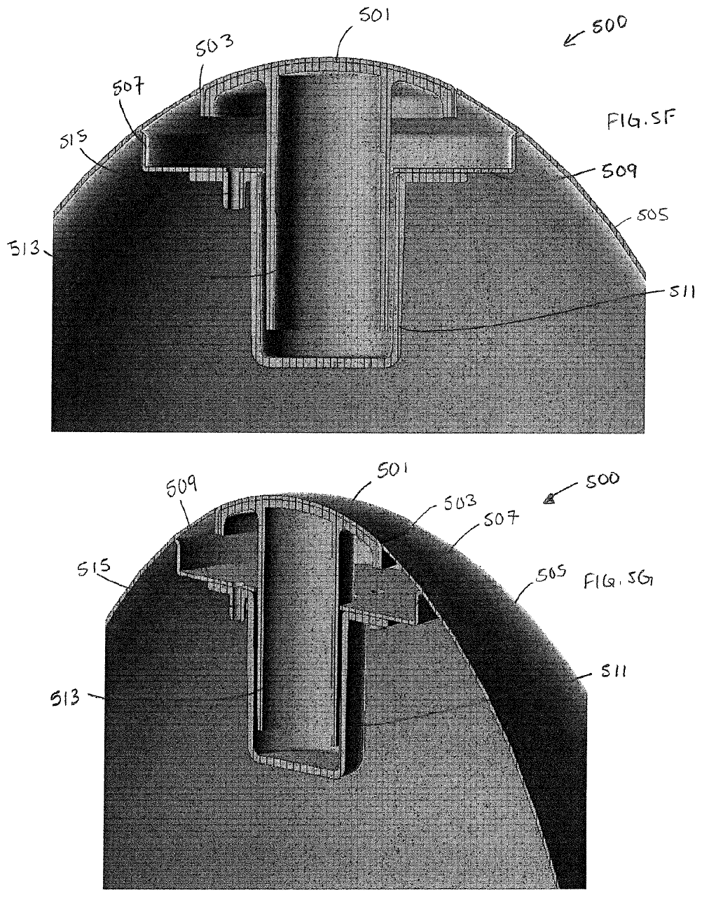

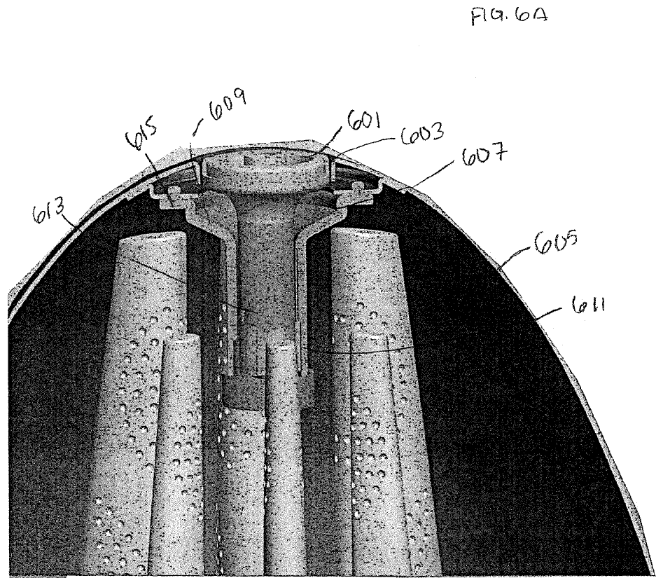

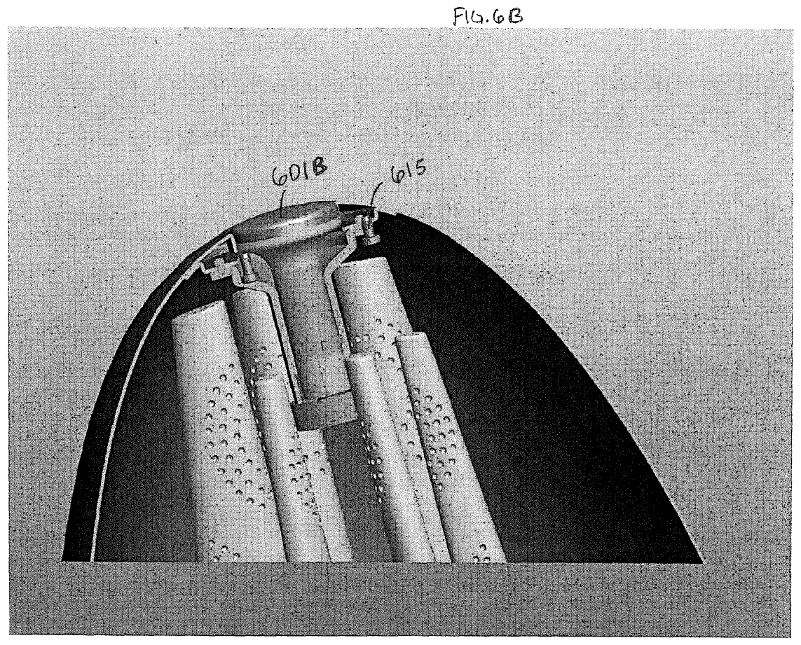

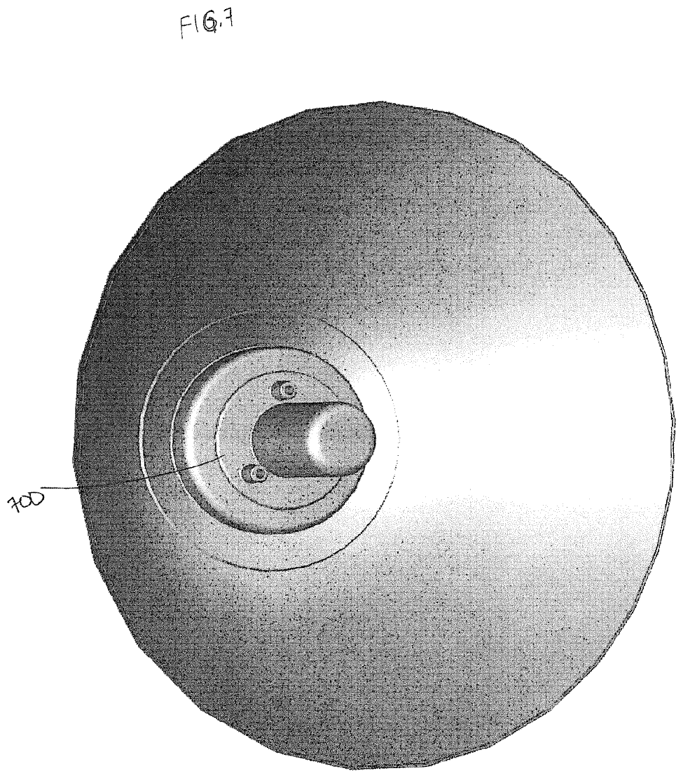

FIG. 4A illustrates a top view of the interior of a container in accordance with some embodiments of the present disclosure. As illustrated the knife block may be configured to receive knives having various handle shapes 413.

FIGS. 4B and 4C illustrate side views of an interior of a container in accordance with some embodiments of the present disclosure. As illustrated the top lid 401 may rest 405 on a bottom portion 403. A knife block 417 may be contained within the interior of the container and be configured to receive knives with sharp edges 415 and handles 413. The bottom portion 403 may include a flat bottom surface 407 configured to sit on a surface such as a kitchen counter. A top surface 409 of lid 401 may have a substantially oval shape such that the container has a substantially egg-shape. Further, a “one touch mechanism” 411 may be positioned about the top surface 409 of the lid 401.

FIG. 4D illustrates a top view of a component of the container, the knife block 417, in accordance with some embodiments of the present disclosure. FIGS. 4E and 4F illustrate side views of a component of the container, the knife block 417, in accordance with some embodiments of the present disclosure. As illustrated, the knife block 417 may be configured to hold knives having various blade shapes, sizes, lengths, widths, and the like. Accordingly, the knife block 417 may have apertures 419 having various sizes and shapes.

In particular, FIGS. 5A-5G illustrates the “one touch mechanism” 500. As illustrated the top lid 505 may include a recessed area 503 in which a handle 501 is sized to fit. The handle 501 may have a diameter equal to that of the recessed area 503. The handle 501 may have arms that extend substantially downwards from its circumference to provide a user with a better grip. The handle 501 may be perpendicularly and integrally connected to a shank 513. In some embodiments, the shank 513 may be cylindrical and configured to engage with a spring that rests within and is fixed to a bottom interior surface of chamber 511. The body of the shank 513 may engage with one or more strikes along the interior of the chamber 511. In some embodiments, the chamber 511 has a generally cylindrical portion (in which the shank moves). A top end of the chamber 511 may protrude outwards from the cylinder and fit with a plate 509 suspended 507 from the lid 505. In some embodiments, the chamber 511 may be screwed onto the plate 509 by way of one or more screws 515. The plate 509 may be configured to be spaced way from the surface of the top lid 505 so as to provide an area in which the handle 501 may lower into the interior of the top lid 505.

In some embodiments the “one touch mechanism” may function by pressing the handle 501 into the space between the recessed area 503 and the plate 509. When pressure is removed, the handle 501 may then spring upwards, such that the handle 501 is no longer flush with the top lid 505, and instead extends from the top lid 505 (in accordance with the position illustrated in FIGS. 5C, 5D, and 5E). The handle 501 may then be used to remove the lid 505 from the bottom of the container. When the handle 501 is placed back on the lid 505, the handle 501 can be pressed back into a resting position where it is flush with the lid 505 (in accordance with the position illustrated in FIGS. 5A, 5B, 5F, and 5G).

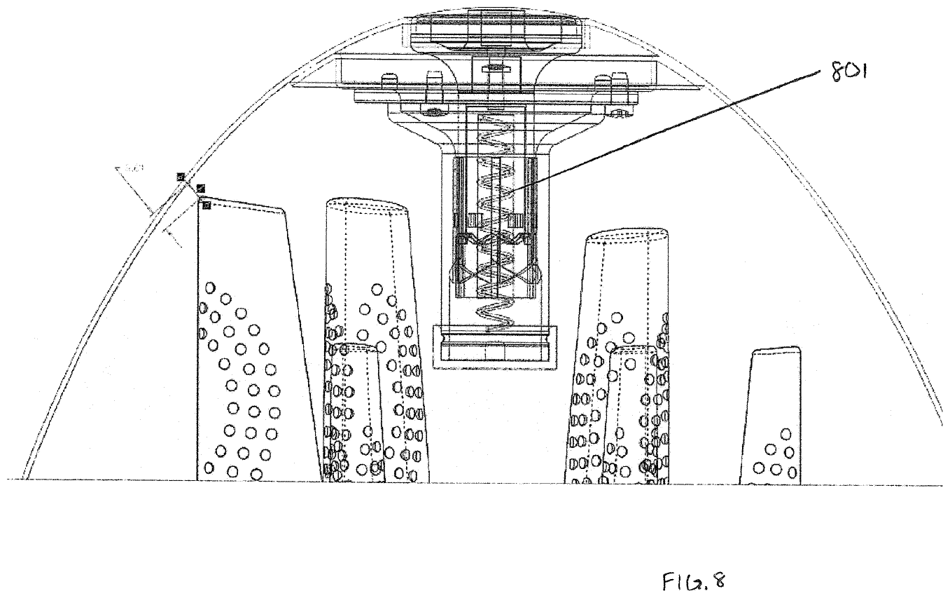

FIGS. 6A and 6B illustrate cross-sectional views of an embodiment of a “one touch mechanism” where the plate 609 forms an angled cavity in which the handle 601 can depress into. Similar to the embodiment discussed above, top lid 605 may include a recessed area 603 in which a handle 601 is sized to fit. The handle 601 may have a diameter equal to that of the recessed area 603. The handle 601 may be perpendicularly and integrally connected to a shank 613. In some embodiments, the shank 613 may be cylindrical and configured to engage with a spring that rests within and is fixed to a bottom interior surface of chamber 611. In some embodiments, the chamber 611 has a generally cylindrical portion (in which the shank moves). A top end of the chamber 611 may protrude outwards from the cylinder and fit with a plate 609 suspended 607 from the lid 605. The plate 609 may provide an angled cavity. In some embodiments, the chamber 611 may be screwed onto the plate 609 by way of one or more screws 615. The plate 609 may be configured to be spaced way from the surface of the top lid 605 so as to provide an area in which the handle 601 may lower into the interior of the top lid 605.

In some embodiments the “one touch mechanism” may function by pressing the handle 601 into the space between the recessed area 603 and the plate 609. When pressure is removed, the handle 601 may then spring upwards, such that the handle 601 is no longer flush with the top lid 605, and instead extends from the top lid 605. The handle 601 may then be used to remove the lid 605 from the bottom of the container. When the handle 601 is placed back on the lid 605, the handle 601 can be pressed back into a resting position where it is flush with the lid 605. The handle 601 may include a handle cover 601B.

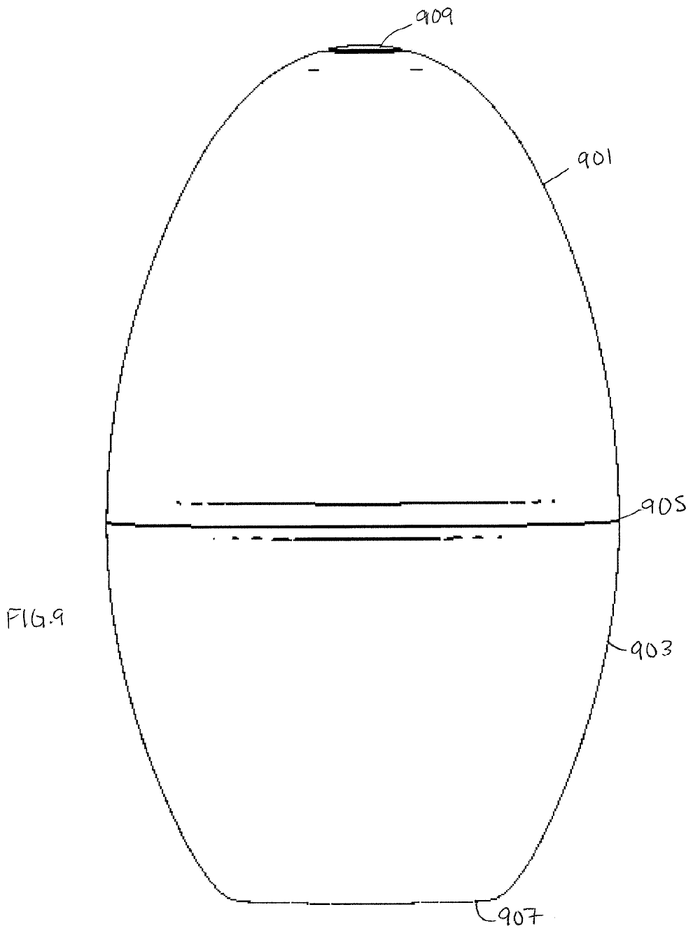

FIG. 7 the interior top surface of a container in accordance with some embodiments of the present disclosure. As depicted, the “one touch mechanism” may be encased 700. In other words, the internal mechanical components of the “one touch mechanism” may not be visible or accessible to a user.

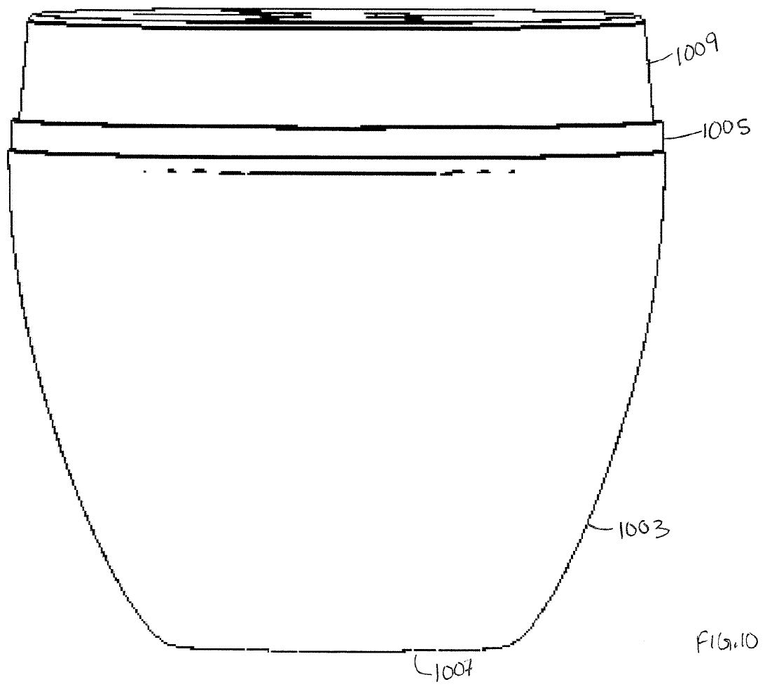

FIG. 8 illustrates a schematic view of a top portion of the container in accordance with some embodiments of the present disclosure. Depicted in FIG. 8 is a spring 801. In some embodiments, a first end of the spring 801 may be configured to engage with a shank and handle assembly. In some embodiments, the second end of the spring 801 may be fixed with a bottom interior surface of a chamber. As the spring flexes within the chamber, the handle may traverse the chamber.

FIG. 9 illustrates a front view of the container in accordance with some embodiments of the present disclosure. As illustrated, the container is egg-shaped with a lid portion 901 and a bottom portion 903 having a flat bottom surface 907 configured to sit on a surface (e.g., kitchen counter). The bottom portion 903 interfaces 905 with the lid portion 901.

Further the lid portion 901 includes a top surface 909 corresponding to a handle portion of a “one touch mechanism” (discussed above).

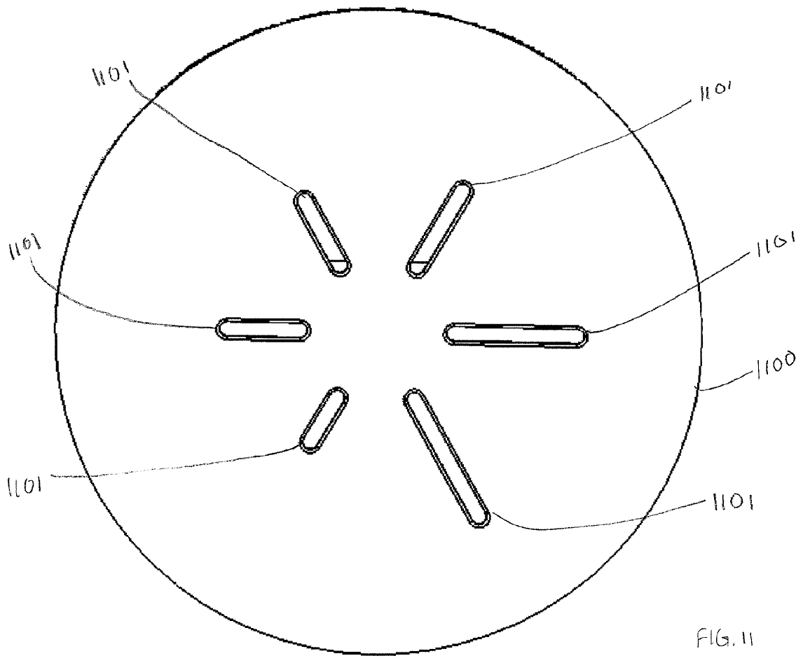

FIG. 10 illustrates a front view of a bottom portion of the container in accordance with some embodiments of the present disclosure. In particular, illustrated is a bottom portion 1003 with a flat bottom surface 1007. Also illustrated is an attachment mechanism 1005, configured for receiving the lid portion of the container. In some embodiments, the attachment mechanism 1005, may be a pressure fit, screw fit, a lip or edge, or a mechanical fit. In some embodiments, the bottom portion 1003 may include a circumferential surface 1009 extending from the attachment mechanism 1005 and configured to engage with at least a portion of the lower interior surface of the lid. Alternative embodiments are envisioned.

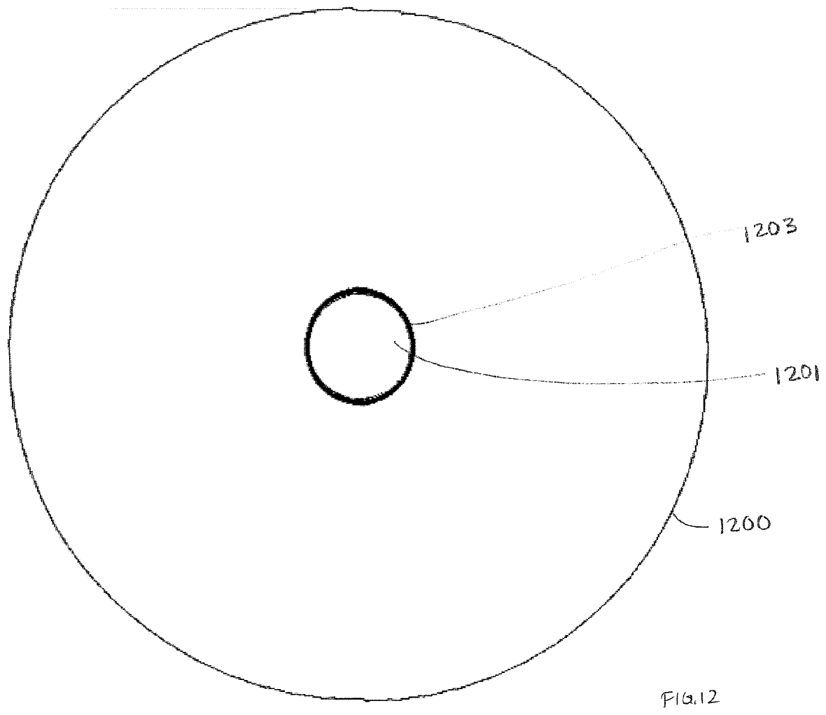

FIG. 11 illustrates a top view of a component of the container in accordance with some embodiments of the present disclosure. In particular, 1100 illustrates a knife block configured to be positioned within the container and configured to receive and hold knives having different sizes. Various configurations, sizes, and orientations for slots 1101 are envisioned.

FIG. 12 illustrates a top view of the container in accordance with some embodiments of the present disclosure. Depicted is a top surface 1203 of the lid 1200 in which a handle built in accordance with the “one touch mechanism” 1201 is fit.

Although the present disclosure may provide a sequence of steps, it is understood that in some embodiments, additional steps may be added, described steps may be omitted, and the like. Additionally, the described sequence of steps may be performed in any suitable order.

While illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified.

Thus, the foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments.

We claim:

1. A container comprising:
a lid portion having a recessed area configured to house a handle, the handle having a top surface configured to fit in the recessed area, the handle being connected to a shank engaged with a chamber by way of a spring; and
a base portion configured to store one or more knives and engage with the lid portion, wherein the handle is in a first position within the recessed area when force is applied to the top surface of the handle, and the handle is in a second position exterior to a surface of the lid portion when the force is removed from the top surface of the handle.

2. The container of claim 1, wherein the container comprises a substantially egg-shape.

3. The container of claim 1, wherein a first end of the spring is fixedly attached to the interior base of the chamber.

4. The container of claim 1, wherein the second end of the spring is fixedly attached to the shank.

5. The container of claim 1, wherein the base portion comprises one or more apertures configured to store the one or more knives.

6. The container of claim 1, wherein the base portion comprises a lip configured to provide a surface onto which the lid portion may rest.

7. A method comprising:
depressing a portion of a handle of a container towards the interior of the container by applying a force, wherein the handle is positioned on a lid of the container;
removing the force applied to the handle such that the handle moves towards the exterior of the container and is located outside of the surface of the container; and
removing the lid from the container via the handle.

8. The method of claim 7, comprising:
engaging the lid with the container, wherein the handle protrudes from the lid; and
depressing the handle such that the handle is flush with an exterior surface of the lid.

9. The method of claim 1, wherein the handle of the container is flush with the exterior surface of the container in a first state.
